(19) United States
(12) Patent Application Publication
(10) Pub. No.: US 2023/0170462 A1
(43) Pub. Date: Jun. 1, 2023

(54) METHOD FOR ATTACHING A CONDUCTIVE TAB TO AN ELECTRODE AND ASSEMBLY THEREIN

(71) Applicants: Zachary FAVORS, Reno, NV (US); NEXTECH BATTERIES, INC., Carson City, NV (US)

(72) Inventor: Zachary FAVORS, Reno, NV (US)

(21) Appl. No.: 17/922,431

(22) PCT Filed: Apr. 29, 2021
(86) PCT No.: PCT/US21/29999

§ 371 Date: Oct. 31, 2022

Related U.S. Application Data
(60) Provisional application No. 63/017,457, filed on Apr. 29, 2020.

(51) Int. Cl. H01M 4/134; H01M 50/536; H01M 50/534; H01M 4/1395

(52) U.S. Cl. CPC H01M 4/134; H01M 50/536; H01M 50/534; H01M 4/1395

(57) ABSTRACT

A method for coupling an electroconductive tab portion to an electrode. A foam component can first be coupled to a foil tab using any suitable method, such as ultrasonic vibration welding. The electrode material can then be mechanically pressed into the foam to couple the tab portion to the electrode. The tab portion and foam can be composed of the same material, including but not limited to a metal, such as nickel. The electrode material can be any suitable material such as lithium. The electrode material can be mechanically coupled to the foam portion by mechanically pressing the electrode material onto the foam, wherein the electrode material flows into one or more voids of the foam component.

### CROSS-REFERENCE TO RELATED APPLICATION

This Patent Application claims priority to U.S. Provisional Application: 63/017,457 filed Apr. 29, 2020, the disclosure of which is considered part of the disclosure of this application and is hereby incorporated by reference in its entirety.

### FIELD OF THE INVENTION

This invention relates generally to batteries and energy storage. In one aspect, the present disclosure relates to batteries and a method for coupling a tab to an electrode.

### BACKGROUND

In the battery industry, it is known that when producing a lithium-ion battery, the battery will need a positive pole tab. Current methods include welding a material pole tab, which has several disadvantages including potentially disturbing the lithium metal of the anode such as oxidizing or melting the lithium anode. There exists a need for safely bonding lithium metal to other metals without the use of beat, vibration, electric discharge, or other methods that compromise the integrity of the lithium anode.

### BRIEF SUMMARY OF THE INVENTION

In one aspect, this disclosure is related to a method of coupling a metal tab to a lithium anode without damaging the integrity of the lithium anode. In some exemplary embodiments, the metal tab is coupled to the lithium anode without the use of heat, vibration, or electric discharge.

In another aspect, this disclosure is related to coupling a metal tab to a lithium anode, wherein a nickel foam component is welded to a nickel foil tab using any suitable method, such as ultrasonic vibration welding. A lithium anode can then be mechanically pressed into the nickel foam to couple the nickel tab to the lithium anode.

In another aspect, this disclosure is related to a battery assembly comprising a tab portion, foam portion, and anode portion. The tab portion can be a nickel tab that is first coupled to a nickel foam portion via an ultrasonic weld. A lithium anode can then be coupled to the tab assembly utilizing a press wherein the lithium will fill any voids or space of the nickel foam portion.

In another aspect, the present disclosure is related to a method of manufacturing a lithium anode assembly by first providing an electroconductive tab portion. An electroconductive foam component can then be coupled to the electroconductive tab portion utilizing any suitable means to generate a foam-tab assembly. In some exemplary embodiments, the foam can be coupled to the tab portion utilizing ultrasonic welding. The foam component can include a plurality of voids. Similarly, the foam portion can have a thickness less than that of the tab portion to allow for additional electrode material. Additionally, the foam portion voids can have ample volume to permit the electrode material to flow into any subsequent steps. The electrode material can then be provided and coupled to the foam component of the foam-tab assembly, wherein the electrode material fills the voids of the foam portion and couples the electrode material to the foam-tab assembly.

In another aspect, the present disclosure is related to an electrode assembly having a foam-tab assembly having a tab portion having a first end and a second end and a foam portion coupled to the second end of the tab portion, wherein the foam portion comprises a plurality of voids. The electrode assembly can further include an electrode portion that can be coupled to the foam portion of the foam-tab assembly. A portion of the electrode portion material occupies one or more of the plurality of voids of the foam portion.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an illustration of exemplary embodiments of a tab of the present disclosure.

FIG. 2 is an illustration of exemplary embodiments of the tabs of FIG. 1 bonded to a piece of metal foam.

FIG. 3 is an illustration of exemplary embodiments of the tabs part of the anode assembly of the present disclosure.

FIG. 4A is an illustration of the anode assembly of the present disclosure before compressing the foam portion to the anode portion of the assembly.

FIG. 4B is an illustration of the anode assembly of the present disclosure after compressing the foam portion to the anode portion of the assembly.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present disclosure relates to method of coupling a metal tab to a lithium anode without damaging the integrity of the lithium anode. In some exemplary embodiments, the metal tab portion 1 can be coupled to the lithium anode without the use of heat, vibration, or electric discharge. A potion of a metal foam or other conductive foam 5, such as nickel foam, can be first welded to the tab portion 1 using any suitable method, such as ultrasonic vibration welding. In some exemplary embodiments, the foil tab 1 can be nickel foil. An anode can then be mechanically pressed into the metal foam via any suitable means, such as a mechanical press. In some embodiments, an arbor press can be used to mechanically press the foam to the anode. Some exemplary embodiments of the anode can include one or more lithium anodes. The resulting composition is a bonded assembly between the anode and the metal tab which can then be used in various types of cells, such as a lithium-sulfur or lithium-ion battery cell. Additionally, the present disclosure provides a facile method for attaching metallic, conducting tabs (nickel or similar) to lithium metal foil anodes that does not rely on welding or disturbing of the lithium metal that would otherwise result in melting or oxidation of the lithium. This provides a safe way of bonding lithium metal to other metals without the use of heat, vibration, or electric discharge.

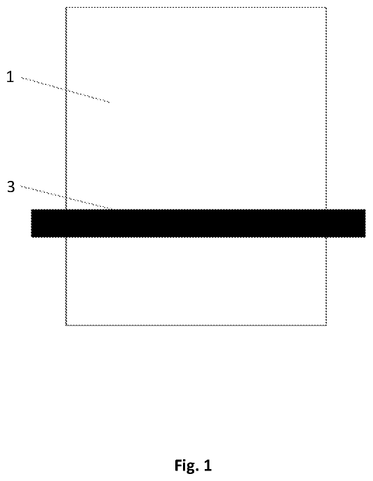

As shown in FIG. 1, the tab assembly can first include a tab portion 1, which can be comprised of any suitable material such as metal, polymer, or other conductive material. In some exemplary embodiments, the tab portion can be a nickel tab 1. A melt polymer 3 or another melt composition can then be formed or supplied to the tab portion 1. In some exemplary embodiments, the melt polymer can be pre-coupled to the tab portion 1 or alternatively can be coupled to the tab portion by heating the polymer to a melting point and attaching the semi-fluid polymer to the tab portion 1. In some exemplary embodiments, the tabs can include a small strip of a melt polymer. The melt polymer 3 can be located between the first end and second end and in some exemplary embodiments can have a diameter greater than the diameter of the tab. The melt polymer can be used to seal a pouch case around the tab.

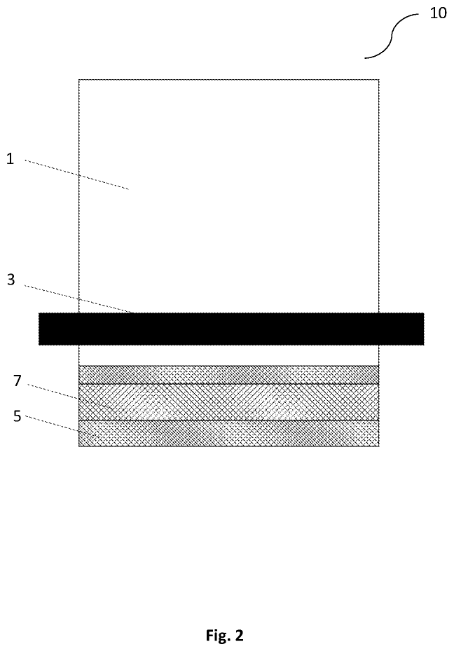

As shown in FIG. 2, a piece of foam can be cut to the same width as the tab portion 1 prior to being coupled to the tab 1. The tabs can be similar in geometry to the tabs illustrated in FIG. 1, or any other suitable geometry. The foam can be comprised of any suitable material, and in some exemplary embodiment can comprise of a metal foam. The composition of the tab portion 1 and the foam portion 5 can be the same or different depending upon the application. In some exemplary embodiments, the tab and foam 5 can be composed of nickel. The tab can have a first end and a second end. The foam portion 5 can first be placed on top of the tab portion 1. The foam 5 can be coupled to the second end of the tab portion utilizing any suitable method. The foam and tab portion can then be coupled across the width of the tab portion. In some exemplary embodiments, the foam 5 and tab portions 1 can be coupled using any suitable means such as welding. In one exemplary embodiment, the foam portion and tab portion can be ultrasonically welded 7 to bond the foam and tab portions. In some exemplary embodiments, the weld 7 can be smaller in thickness than the foam portion to permit ample volume for the anode material to flow into any subsequent steps. Additionally, the foam 5 itself can have suitable surface area and/or volume to bond to the electrode material. The plurality of cavities or voids of the foam 5 can have varying amounts of volume and surface area to allow for the electrode material to readily be compressed into the cavities to ensure coupling of the electrode material to the foam-tab assembly 10. The electrode and/or anode material can be any suitable material, including but not limited to lithium. The welded portion can be located proximate to a melt polymer 3. In other exemplary embodiments, the tab portion 1 and foam portion 5 can be mechanically compressed together. The tab portion 1, melt polymer 3, and coupled foam 7 to the tab 1 can form a foam-tab assembly 10 that can then be coupled to one or more electrodes, such as an anode. In some exemplary embodiment, the metal polymer 3 can be an optional component of the foam-tab assembly 10.

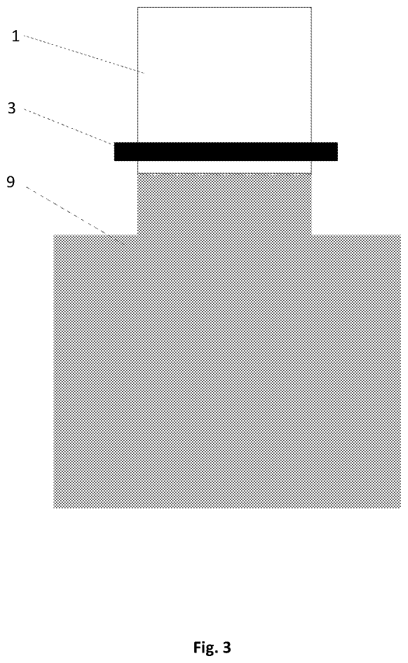

FIG. 3 illustrates the anode portion 9 being positioned over the foam-tab assembly 10 portion. In some exemplary embodiments, the anode 9 can be comprised of lithium foil which can have a thickness of between about 10 microns to about 500 microns, or about 20 microns to about 400 microns. In one exemplary embodiment, a lithium foil anode 9 can be positioned over a nickel-nickel foam-tab assembly 10. In some embodiments, a spacer portion 11 of the nickel tab can be exposed between the melt polymer and the foam portion. The spacer portion 11 can allow for proper sealing of the cell during manufacturing/fabrication. Additionally, if the spacer portion 11 is omitted there is the possibility of damage to any packaging of the cell by the weld 7. The second end of the tab portion including the foam portion 5 can then be coupled to the first end of the anode 9.

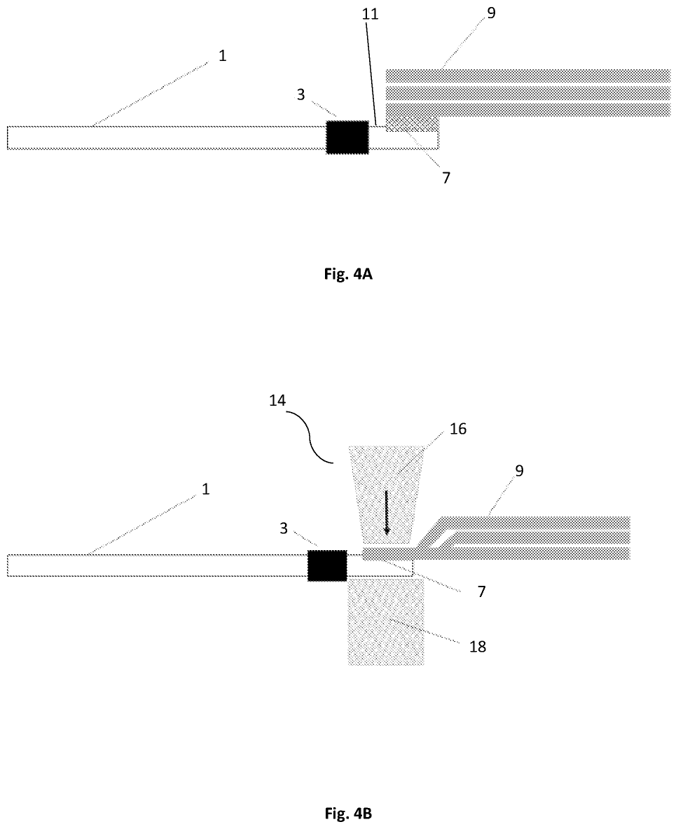

FIGS. 4A-4B show side view a stack including the tab portion 1, foam portion 5, and anode portion 9. In some exemplary embodiments, the assembly can include a nickel tab-nickel foam and lithium anode. The anode material can be compressed via a mechanical press, such as an arbor press rack pad 16 and table portion 18. The anode portion 9 can be compressed with and coupled to the foam portion 5 of the foam-tab assembly 10. One or more anodes can be compressed into the foam portion 5, which provides the ability for the anode material to be pressed into the voids/cavities of the foam and compress the foam portion thereby forming a bond between the foam portion 5 and anode portion 9. In some exemplary embodiments, a lithium anode is able to bond to the nickel tab assembly having a nickel foam portion.

The formed assembly can then be used in cells, such as battery cells. In certain embodiments, the lithium anode embodiment can be used for lithium-sulfur or lithium-ion cells. The present disclosure provides an embedded anode matrix within the metal foam to form a much stronger bond that traditional bonding methods. In one exemplary embodiment, the welded nickel-nickel foam tab assembly and subsequent mechanical compression of the assembly into lithium, versus the tradition use of ultrasonic or spot welding, thereby forming an embedded lithium matrix within the nickel foam. In some other exemplary embodiments, the anode material can be mechanically compressed into the metal tab without the use of a foam portion. In other exemplary embodiments, the mechanical press can include a corrugated or perforated punch.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. The method of manufacturing a lithium anode assembly, comprising:
providing an electroconductive tab portion;
coupling a foam component to the electroconductive tab portion to form a foam-tab assembly, wherein the foam component includes a plurality of voids;
providing an electrode material; and
coupling the electrode material to the foam component of the foam-tab assembly, wherein the electrode material fills the voids of the foam portion and couples the electrode material to the foam-tab assembly.

2. The method of claim 1, wherein the tab portion and foam portion are coupled by an ultrasonic weld.

3. The method of claim 2, wherein the tab and the foam is comprised of nickel.

4. The method of claim 3, wherein the tab assembly is coupled to the anode using a mechanical press.

5. The method of claim 4, wherein the mechanical press is an arbor press.

6. An electrode assembly comprising:
a foam-tab assembly having a tab portion having a first end and a second end and a foam portion coupled to the second end of the tab portion, wherein the foam portion comprises a plurality of voids; and
an electrode material coupled to the foam portion of the foam-tab assembly, wherein a portion of the electrode material occupies one or more of the plurality of voids of the foam portion.

7. The assembly of claim 6, wherein the tab portion and foam portion are coupled together by ultrasonically welding across a width of the tab portion.

8. The assembly of claim 7, wherein the anode assembly further includes a melt polymer between the first end of the tab portion and the foam portion.

9. The assembly of claim 8, wherein the foam portion is comprised of a first material and the tab portions is comprised of a second material.

10. The assembly of claim 9, wherein the first material and second material are different.

11. The assembly of claim 9, wherein the first material and second material are the same.

12. The assembly of claim 11, wherein the first material and second material is nickel.

13. The assembly of claim 12, wherein the electrode material is comprised of lithium.

14. The assembly of claim 6, wherein the foam portion is a nickel foam, the tab portion is a nickel tab, and the electrode material is lithium.

15. The assembly of claim 14, wherein lithium forms an embedded lithium matrix within the nickel foam when compressed into the nickel foam of the foam portion.

16. The assembly of claim 15, wherein the nickel foam is coupled to the tab portion by ultrasonically welding the nickel foam across a width of the tab portion.

17. The assembly of claim 16, further comprising a melt polymer between the first end of the tab portion and the foam portion.

18. The assembly of claim 17, wherein a spacer portion of the tab portion is located between the foam portion and the melt polymer.

19. The assembly of claim 18, wherein the foam portion has a thickness less than the tab portion configured to permit ample volume for the electrode material to flow into foam portion.
